(19) United States
(12) Patent Application Publication
(10) Pub. No.: US 2007/0135544 A1
(43) Pub. Date: Jun. 14, 2007

(54) Polycarbonate molding compositions

(75) Inventors: Andreas Seidel, Dormagen (DE); Dieter Wittmann, Leverkusen (DE); Christoph Schwemler, Leichlingen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/633,972

(22) Filed: Dec. 5, 2006

(30) Foreign Application Priority Data
Dec. 9, 2005 (DE) 102005058847.6

(51) Int. Cl. C08K 5/00

(52) U.S. Cl. 524/284; 524/504

(57) ABSTRACT

A stabilized thermoplastic molding composition is disclosed. The composition contains A) aromatic polycarbonate and/or polyester carbonate, B) a rubber-modified graft polymer or its mixture with a rubber-free (co)polymer and C) a Bronsted acid compound. The inventive composition is characterized in its improved stability under processing conditions. Also disclosed is a process for the production of the composition and its use for the production of shaped articles.

### FIELD OF THE INVENTION

The invention relates to thermoplastic compositions and in particular to compositions containing polycarbonate and rubber-modified graft polymer.

### TECHNICAL BACKGROUND OF THE INVENTION

Thermoplastic molding compositions comprising polycarbonates and ABS polymers (acrylonitrile/butadiene/styrene) have been known for a long time. U.S. Pat. No. 3,130,177 A, for example, describes readily processable molding compositions comprising polycarbonates and graft polymers of monomer mixtures of acrylonitrile and an aromatic vinyl hydrocarbon on polybutadiene. These molding compositions are distinguished by good toughness both at room temperature and at low temperatures, good melt fluidity and high heat resistance.

A disadvantage of such molding compositions is that, to avoid harmful effects on the polycarbonate and associated impairments of the properties caused by manufacture, processing or ageing, they must not contain certain constituents, such as e.g. substances acting as bases and certain inorganic metal compounds, particularly oxidic (transition) metal compounds, in significant quantities, since at high temperatures, such as those typically occurring during the production and processing of the molding compositions, and with prolonged exposure to a hot, humid atmosphere, these constituents generally decompose the polycarbonate catalytically. This polycarbonate degradation is often expressed as damage to the properties of the molding compositions, particularly the mechanical characteristics such as ductility and elongation properties. As a result, the choice of substances to use for these compositions is severely limited. For example, only those ABS polymers that are free from impurities acting as bases may be used. However, ABS polymers that are not intended from the start to be mixed with polycarbonates often contain, as a result of their production, residual quantities of substances acting as bases, which are employed as polymerization auxiliaries e.g. in emulsion polymerization or as auxiliary substances in the work-up processes. In some cases, additives acting as bases are also added to ABS polymers deliberately (e.g. lubricants and mold release agents). In addition, many commercially available polymer additives cannot be used in impact-modified polycarbonate (PC) compositions, or may only be used at considerable compromise of the properties of the compositions, since either they act as bases or they contain constituents/impurities acting as bases resulting from their production. Examples of these additives may be mold release agents, antistatic agents, stabilizers, light stabilizers, flame retardants and colorants. Moreover, the use of oxidic metal compounds, e.g. in the form of certain pigments (e.g. titanium dioxide, iron oxide) and/or fillers and reinforcing materials (e.g. talc, kaolin etc.) often leads to considerable, undesirable losses of processing stability in the compositions.

PC/ABS compositions (polycarbonate/acrylonitrile/butadiene/styrene) are known from U.S. Pat. No. 4,299,929, which are characterized in that inorganic acids, organic acids or organic acid anhydrides are added. The resulting molding compositions are distinguished by improved thermal stability.

From EP-A 0576950, PC/ABS compositions are known with a combination of high toughness and a good surface finish and, at the same time, good heat resistance and ball indentation hardness, which are characterized in that a compound with a molecular weight of 150 to 260 g/mol having several carboxyl groups is contained. The compositions disclosed in EP-A 0576950 preferably contain 50 to 100 parts by weight of ABS, 1 to 50 parts by weight of polycarbonate and 0.2 to 5 parts by weight of the compound containing several carboxyl groups.

In U.S. Pat. No. 5,608,027 Polycarbonate compositions are discloses which comprise emulsion-modified impact modifier whereby the mixture is stabilized by adding phosphorous containing acid and phosphite.

The object of the invention is to provide impact-modified polycarbonate compositions suitable for the production of articles having complex shape, the compositions distinguished by improved processing stability, good hydrolysis resistance and a light natural shade (i.e. low Yellowness index YI).

### SUMMARY OF THE INVENTION

A stabilized thermoplastic molding composition is disclosed. The composition contains A) aromatic polycarbonate and/or polyester carbonate, B) a rubber-modified graft polymer or its mixture with a rubber-free (co)polymer and C) a member selected from the group consisting of aliphatic organic carboxylic acid and aromatic organic carboxylic acid. The inventive composition is characterized in its improved stability under processing conditions. Also disclosed is a process for the production of the composition and its use for the production of shaped articles.

### DETAILED DESCRIPTION OF THE INVENTION

It has been found that impact-modified polycarbonate compositions containing constituents that degrade polycarbonate under the typical processing conditions thereof exhibit clearly improved processing stability with good hydrolysis resistance and a light natural shade if certain acids are added in very small amounts. The acid according to the invention is preferably one that decomposes under the thermal conditions of compounding, and releases volatile compounds and/or compounds which act neither as Broensted acid nor as base.

The present invention therefore provides thermoplastic molding compositions containing
A) 10 to 90 parts by weight, preferably 40 to 80 parts by weight, especially 55 to 75 parts by weight, of at least one member selected from the group consisting of aromatic polycarbonate and polyester carbonate,
B) 10 to 90 parts by weight, preferably 20 to 60 parts by weight, especially 25 to 45 parts by weight, of (B.1) rubber-modified graft polymer or a mixture of B.1 with (B.2) rubber-free (co)polymer of at least one monomer selected from the group consisting of vinyl aromatics, vinyl cyanides (unsaturated nitriles), C₁-C₈ alkyl(meth)acrylates, unsaturated carboxylic acids and derivatives (such as anhydrides and imides) of unsaturated carboxylic acids, and
C) 0.005 to 0.15 parts by weight, preferably 0.01 to 0.15 parts by weight, especially 0.015 to 0.13 parts by weight, based on 100 parts by weight of the sum of components A and B, of at least one member selected from the group consisting of aliphatic organic carboxylic acid and aromatic organic carboxylic acid,
   whereby component C) is mixed with the melt of components A) and B) or whereby component C) is in a first step premixed with component B) and in a second step the resulting mixture of A) and B) is mixed with a melt comprising component A).
   Component A

Aromatic polycarbonates and/or aromatic polyester carbonates suitable as component A are known from the literature or may be produced by known processes (for the production of aromatic polycarbonates, cf. e.g. Schnell, “Chemistry and Physics of Polycarbonates”, Interscience Publishers, 1964, as well as DE-AS 1 495 626, DE-A 2 232 877, DE-A 2 703 376, DE-A 2 714 544, DE-A 3 000 610 and DE-A 3 832 396; for the production of aromatic polyester carbonates, e.g. DE-A 3 077 934).

Aromatic polycarbonates are produced e.g. by reacting aromatic dihydroxy compounds, especially diphenols with carbonic acid halides, preferably phosgene, and/or with aromatic dicarboxylic acid dihalides, preferably benzenedicarboxylic acid dihalides, by the interfacial polycondensation process, with the optional use of chain terminators, e.g. monophenols, and with the optional use of branching agents, that are compounds having functionality of three or more e.g. triphenols or tetraphenols. These resins may also be produced by a melt polymerization process by reacting diphenols with, for example, diphenyl carbonate.

Aromatic dihydroxy compounds for the production of the aromatic polycarbonates and/or aromatic polyester carbonates are preferably those of formula (I) 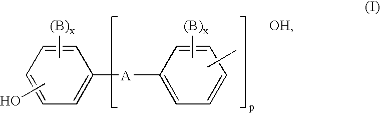
wherein
A is a single bond, C₁ to C₅ alkylene, C₂ to C₅ alkylidene, C₅ to C₆ cycloalkylidene, —O—, —SO—, —CO—; —S—, —SO2—, C₆ to C₁₂ arylene on which other aromatic rings, optionally containing heteroatoms, may be condensed,
   or a radical of formula (II) or (III) 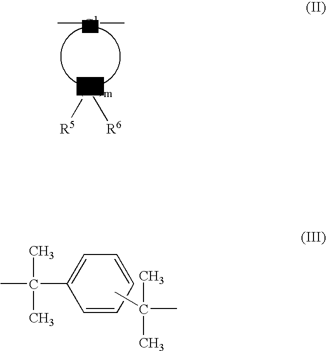
B is, in each case, C₁ to C₁₂ alkyl, preferably methyl, halogen, preferably chlorine and/or bromine
x, each independently of the other, is 0, 1 or 2,
p is 1 or 0 and
R⁵ and R⁶is selected for each X¹ individually and independently of one another denote hydrogen or C₁ to C₆ alkyl, preferably hydrogen, methyl or ethyl,
X¹ is carbon and
m is an integer from 4 to 7, preferably 4 or 5, with the proviso that on at least one X¹ atom, R⁵ and R⁶ are both alkyl radicals.

Preferred aroatic dihydroxy compounds are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes, as well as the ring-brominated and/or ring-chlorinated derivatives thereof.

Particularly preferred are 4,4′-dihydroxydiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenylsulfide, 4,4′-dihydroxydiphenylsulfone and the di- and tetrabrominated or chlorinated derivatives thereof, such as e.g. 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis(4-hydroxyphenyl)propane (bisphenol A) is particularly preferred.

The aromatic dihydroxy compounds may be used individually or as any mixtures. These compounds are known and may be obtained by known processes.

Suitable chain terminators for the production of the thermoplastic, aromatic polycarbonates are, for example, phenol, p-chlorophenol, p-tert.-butylphenol or 2,4,6-tribromophenol, but also long-chain alkylphenols, such as 4-[2-(2,4,4-trimethylpentyl)]phenol, 4-(1,3-tetramethylbutyl)phenol according to DE-A 2 842 005 (U.S. Pat. No. 4,269,964 incorporated herein by reference) or monoalkylphenol or dialkylphenols with a total of 8 to 20 carbon atoms in the alkyl substituents, such as 3,5-di-tert.-butylphenol, p-iso-octylphenol, p-tert.-octylphenol, p-dodecylphenol and 2-(3,5-dimethylheptyl)phenol and 4-(3,5-dimethylheptyl)phenol. The quantity of chain terminators to be used is generally between 0.5 mole % and 10 mole %, based on the molar sum of the aromatic dihydroxy compounds used in each case.

The thermoplastic, aromatic polycarbonates have weight-average molecular weights (M_{w}) measured e.g. by GPC, ultracentrifuge or light-scattering measurement) of 10,000 to 200,000 g/mol, preferably 15,000 to 80,000 g/mol, particularly preferably 24,000 to 32,000 g/mol.

The thermoplastic, aromatic polycarbonates may be branched in a known manner, preferably by incorporating 0.05 to 2.0 mole %, based on the sum of the diphenols used, of compounds having functionalities of three or more, e.g. those with three or more phenolic groups.

Both homopolycarbonates and copolycarbonates are suitable. Included among the suitable copolycarbonates of the invention are copolycarbonates where, 1 to 25 wt. %, preferably 2.5 to 25 wt. %, based on the total quantity of aromatic dihydroxy compounds are polydiorganosiloxanes with hydroxyaryloxy end groupsare used. These are known (U.S. Pat. No. 3,419,634 incorporated herein by reference) and may be produced by known processes. The production of copolycarbonates containing polydiorganosiloxanes is described in DE-A 3 334 782 (U.S. Pat. No. 4,584,360 incorporated herein by reference).

Preferred polycarbonates are, in addition to the bisphenol A homopolycarbonates, the copolycarbonates of bisphenol A with up to 15 mole %, based on the molar sums of aromatic dihydroxy compounds, of other aromatic dihydroxy compounds mentioned as preferred or particularly preferred, especially 2,2-bis(3,5-dibromo-4-hydroxyphenyl)propane.

Aromatic dicarboxylic acid dihalides for the production of aromatic polyester carbonates are preferably the diacid dichlorides of isophthalic acid, terephthalic acid, diphenyl ether-4,4′-dicarboxylic acid and naphthalene-2,6-dicarboxylic acid.

Particularly preferred are mixtures of the diacid dichlorides of isophthalic acid and terephthalic acid in a ratio of between 1:20 and 20:1.

In the production of polyester carbonates, a carbonic acid halide, preferably phosgene, is additionally incorporated as a bifunctional acid derivative.

Suitable chain terminators for the production of the aromatic polyester carbonates are, in addition to the monophenols already mentioned, their chlorocarbonates and the acid chlorides of aromatic monocarboxylic acids, which may optionally be substituted by C₁ to C₂₂ alkyl groups or by halogen atoms, as well as aliphatic C₂ to C₂₂ monocarboxylic acid chlorides.

The quantity of chain terminators is 0.1 to 10 mole % in each case, based in the case of the phenolic chain terminators on moles of diphenol and in the case of monocarboxylic acid chloride chain terminators on moles of dicarboxylic acid dichloride.

The aromatic polyester carbonates may also contain incorporated aromatic hydroxycarboxylic acids.

The aromatic polyester carbonates may be either linear or branched by a known method (cf. DE-A 2 940 024 and DE-A 3 007 934 =corresponding respectively to U.S. Pat. No. 4,334,053 and CA 1173998 incorporated herein by reference).

Examples of branching agents that may be used are tri- or polyfunctional acyl chlorides, such as trimesic acid trichloride, cyanuric acid trichloride, 3,3′-,4,4′-benzophenonetetracarboxylic acid tetrachloride, 1,4,5,8-naphthalenetetracarboxylic acid tetrachloride or pyromellitic acid tetrachloride, in quantities of 0.01 to 1.0 mole % (based on dicarboxylic acid dichlorides used) or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4′-dihydroxytriphenyl)-methyl]benzene, in quantities of 0.01 to 1.0 mole %, based on diphenols used. Phenolic branching agents may be presented with the diphenols; acid chloride branching agents may be added together with the acid dichlorides.

In the thermoplastic, aromatic polyester carbonates, the proportion of carbonate structural units may be varied at will. The proportion of carbonate groups is preferably up to 100 mole %, especially up to 80 mole %, particularly preferably up to 50 mole %, based on the sum of ester groups and carbonate groups. Both the ester portion and the carbonate portion of the aromatic polyester carbonates may be present in the form of blocks or randomly distributed in the polycondensate.

The relative solution viscosity (ηᵣₑₗ) of the aromatic polycarbonates and polyester carbonates is in the range of 1.18 to 1.4, preferably 1.20 to 1.32 (measured in solutions of 0.5 g polycarbonate or polyester carbonate in 100 ml methylene chloride solution at 25° C.).

The thermoplastic aromatic polycarbonates and polyester carbonates may be used individually or in any mixture.

Component B

The component B.1 comprises one or more graft polymers of
B.1.1 5 to 95, preferably 30 to 90 wt. % of at least one vinyl monomer on
B:1.2 95 to 5, preferably 70 to 10 wt. % of one or more rubber backbones having glass transition temperature of <10° C., preferably <0° C., particularly preferably<−20° C.

The backbone B.1.2 has a median particle size (d₅₀ value) of 0.05 to 10 μm, preferably 0.1 to 5 μm, particularly preferably 0.15 to 1 μm.
B.1.1 is preferably a mixture of monomers
B.1.1.1 50 to 99 parts by weight of vinyl aromatics and/or ring-substituted vinyl aromatics (such as styrene, α-methylstyrene, p-methylstyrene, p-chlorostyrene) and/or (C₁-C₈) alkyl methacrylates, such as methyl methacrylate, ethyl methacrylate, and
B.1.1.2 1 to 50 parts by weight of vinyl cyanides (unsaturated nitrites, such as acrylonitrile and methacrylonitrile) and/or (C₁-C₈) alkyl(meth)acrylates, such as methyl methacrylate, n-butyl acrylate, t-butyl acrylate, and/or derivatives (such as anhydrides and imides) of unsaturated carboxylic acids, e.g. maleic anhydride and N-phenylmaleimide
   with the proviso that in the mixture B.1.1.1 differs from B.1.1.2.

Preferred B.1.1.1 is at least one monomer selected from the group consisting of styrene, α-methylstyrene and methyl methacrylate; preferred B.1.1.2 is at least one monomer selected from the group consisting of acrylonitrile, maleic anhydride and methyl methacrylate. Particularly preferred monomer of B.1.1.1 is styrene and that of B.1.1.2 is acrylonitrile.

Suitable backbones B.1.2 include diene rubbers, EP(D)M rubbers, i.e. those based on ethylene/propylene and optionally diene, acrylate, polyurethane, silicone, chloroprene and ethylene/vinyl acetate rubbers as well as silicone/acrylate composite rubbers.

Preferred backbones B.1.2 are diene rubbers, e.g. based on butadiene or isoprene, or mixtures of diene rubbers or copolymers of diene rubbers or mixtures thereof with other copolymerizable monomers (e.g. according to B.1.1.1 and B.1.1.2), with the proviso that the glass transition temperature of component B.2 is less than <10° C., preferably <0° C., particularly preferably<−20° C. Rubber based solely on polybutadiene is particularly preferred.

Particularly preferred polymers B.1 are, for example, ABS polymers (emulsion, bulk and suspension ABS), as described e.g. in DE-OS 2 035 390 (=U.S. Pat. No. 3,644,574 incorporated herein by reference) or in DE-OS 2 248 242 (GB 1 409 275 incorporated herein by reference) and in Ullmanns, Enzyklopädie der Technischen Chemie, vol. 19 (1980), pp. 280 ff. The gel content of the backbone B.1.2 is at least 30 wt. %, preferably at least 40 wt. % (measured in toluene).

The graft copolymers B.1 may be produced by free-radical polymerization, e.g. by emulsion, suspension, solution or bulk polymerization, preferably by emulsion or bulk polymerization, particularly preferably by emulsion polymerization.

Particularly suitable graft rubbers are also ABS polymers produced by redox initiation with an initiator system comprising organic hydroperoxide and ascorbic acid according to U.S. Pat. No. 4,937,285 incorporated herein by reference.

Since it is known that the graft monomers are not necessarily grafted on to the backbone completely during the graft reaction, graft polymers B.1 according to the invention are also intended to mean those products obtained by (co)polymerization of the graft monomers in the presence of the backbone and also forming during work-up.

Suitable acrylate rubbers according to B.1.2 are preferably polymers of alkyl acrylates, optionally with up to 40 wt. %, based on B.1.2, of other polymerizable, ethylenically unsaturated monomers. The preferred polymerizable acrylates include C₁ to C₈ alkyl esters, e.g. methyl, ethyl, butyl, n-octyl and 2-ethylhexyl esters; halogen alkyl esters, preferably halogen C₁-C₈ alkyl esters, such as chloroethyl acrylate, and mixtures of these monomers.

For crosslinking purposes, monomers with more than one polymerizable double bond may be copolymerized. Preferred examples of crosslinking monomers are esters of unsaturated monocarboxylic acids with 3 to 8 C atoms and unsaturated monohydric alcohols with 3 to 12 C atoms, or saturated polyols with 2 to 4 OH groups and 2 to 20 C atoms, such as ethylene glycol dimethacrylate, allyl methacrylate; polyunsaturated heterocyclic compounds, such as trivinyl and triallyl cyanurate; polyfunctional vinyl compounds, such as di- and trivinylbenzenes; also triallyl phosphate and diallyl phthalate. Preferred crosslinking monomers are allyl methacrylate, ethylene glycol dimethacrylate, diallyl phthalate and heterocyclic compounds containing at least three ethylenically unsaturated groups. Particularly preferred crosslinking monomers are the cyclic monomers triallyl cyanurate, triallyl isocyanurate, triacryloylhexahydro-s-triazine and triallyl benzenes. The quantity of crosslinked monomers is preferably 0.02 to 5, especially 0.05 to 2 wt. %, based on the backbone B.1.2. In the case of cyclic crosslinking monomers with at least three ethylenically unsaturated groups, it is advantageous to limit the quantity to less than 1 wt. % of the backbone B.1.2.

Preferred “other” polymerizable, ethylenically unsaturated monomers, which may optionally be used in addition to the acrylates to produce the backbone B.1.2, are e.g. acrylonitrile, styrene, α-methylstyrene, acrylamides, vinyl-C₁-C₆-alkyl ethers, methyl methacrylate, butadiene. Preferred acrylate rubbers as the backbone B.1.2 are emulsion polymers having a gel content of at least 60 wt. %.

Other suitable backbones according to B.1.2 are silicone rubbers with graft-active sites, as described in DE-OS 3 704 657, DE-OS 3 704 655, DE-OS 3 631 540 (respectively U.S. Pat. Nos. 4,859,740; 4,861,831; and 4,806,593 all incorporated herein by reference) and DE-OS 3 631 539.

The gel content of the backbone B.1.2 is determined in a suitable solvent at 25° C. (M. Hoffinann, H. Krömer, R. Kuhn, Polymeranalytik I and II, Georg Thieme-Verlag, Stuttgart 1977).

The median particle size (d₅₀) is the diameter having 50 wt. % of the particles lying above it and 50 wt. % below. It may be determined by ultracentrifuge measurement (W. Scholtan, H. Lange, Kolloid, Z. und Z. Polymere 250 (1972), 782-1796).

Component B may additionally contain homopolymers and/or copolymers B.2 of at least one monomer selected from the group consisting of vinyl aromatics, vinyl cyanides (unsaturated nitriles), C₁-C₈ alkyl(meth)acrylates, unsaturated carboxylic acids and derivatives (such as anhydrides and imides) of unsaturated carboxylic acids.

Particularly suitable as B.2 are copolymers of
B.2.1 50 to 99 wt. %, based on B.2, of at least one monomer selected from the group consisting of vinyl aromatics (such as e.g. styrene, α-methylstyrene), ring-substituted vinyl aromatics (such as e.g. p-methylstyrene, p-chlorostyrene) and C₁-C8 alkyl(meth)acrylates (such as e.g. methyl methacrylate, n-butyl acrylate, tert.-butyl acrylate), and

B.2.2 1 to 50 wt. %, based on B.2, of at least one monomer selected from the group consisting of vinyl cyanides (such as e.g. unsaturated nitriles such as acrylonitrile and methacrylonitrile), C₁-C₈ alkyl(meth)acrylates (such as e.g. methyl methacrylate, n-butyl acrylate, tert.-butyl acrylate), unsaturated carboxylic acids and derivatives of unsaturated carboxylic acids (e.g. maleic anhydride and N-phenylmaleimide),

with the proviso that B.2.1 differs from B.2.2.

These (co)polymers B.2 are resin-like, thermoplastic and rubber-free. The copolymer of styrene and acrylonitrile is particularly preferred.

Such (co)polymers B.2 are known and may be produced by free-radical polymerization, particularly by emulsion, suspension, solution or bulk polymerization. The (co)polymers preferably possess molecular weights M_{w} (weight average, determined by GPC, light scattering or sedimentation) of between 15,000 and 250,000.

A pure graft polymer B.1 or a mixture of several graft polymers according to B.1, or a mixture of at least one graft polymer B.1 with at least one (co)polymer B.2, may be used as component B. If mixtures of several graft polymers or mixtures of at least one graft polymer with at least one (co)polymer are used, these may be used separately or in the form of a precompound in the production of the compositions according to the invention.

Those components B containing constituents that degrade polycarbonate under typical processing conditions are also particularly suitable for the compositions according to the invention. In particular, those components B containing substances acting as bases resulting from their production are also suitable. These may be, for example, residues of auxiliary substances, which are used in the emulsion polymerization or in the corresponding work-up processes, or deliberately added polymer additives, such as lubricants and mold release agents.

Component C

Preferred component C includes at least one member selected from the group consisting of aliphatic dicarboxylic acids, aromatic dicarboxylic acids and hydroxyfunctionalised dicarboxylic acids.

Citric acid, oxalic acid, terephthalic acid or mixtures of these compounds are especially preferred as component C.

In a preferred embodiment, component C is a compound that undergoes thermal decomposition under the conditions of compounding, the degradation accompanied by the release of volatile compounds and/or compounds which act neither as a Broensted acid nor as base.

D) Other Components

The composition may contain other additives as component D.

For example, other polymer constituents such as polyalkylene terephthalates may be added to the composition.

The polyalkylene terephthalates are reaction products of aromatic dicarboxylic acids or their reactive derivatives, such as dimethyl esters or anhydrides, and aliphatic, cycloaliphatic or araliphatic diols, as well as mixtures of these reaction products.

Preferred polyalkylene terephthalates contain at least 80 wt. %, preferably at least 90 wt. %, based on the dicarboxylic acid component, of terephthalic acid groups and at least 80 wt. %, preferably at least 90 mole %, based on the diol component, of ethylene glycol and/or 1,4-butanediol groups.

In addition to terephthalic acid groups, the preferred polyalkylene terephthalates may contain up to 20 mole %, preferably up to 10 mole %, of groups of other aromatic or cycloaliphatic dicarboxylic acids with 8 to 14 C atoms or aliphatic dicarboxylic acids with 4 to 12 C atoms, such as e.g. groups of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

In addition to ethylene glycol or 1,4-butanediol groups, the preferred polyalkylene terephthalates may contain up to 20 mole %, preferably up to 10 mole %, of other aliphatic diols with 3 to 12 C atoms or cycloaliphatic diols with 6 to 21 C atoms, e.g. groups of 1,3-propanediol, 2-ethyl-1,3-propanediol, neopentyl glycol, 1,5-pentanediol, 1,6-hexanediol, 1,4-cyclohexanedimethanol, 3-ethyl-2,4-pentanediol, 2-methyl-2,4-pentanediol, 2,2,4-trimethyl-1,3-pentanediol, 2-ethyl-1,3-hexanediol, 2,2-diethyl-1,3-propanediol, 2,5-hexanediol, 1,4-di-(β-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxypropoxyphenyl)propane (DE-A 2 407 674, 2 407 776, 2 715 932).

The polyalkylene terephthalates may be branched by incorporating relatively small amounts of 3- or 4-hydric alcohols or 3- or 4-basic carboxylic acids, e.g. according to DE-A 1 900 270 and U.S. Pat. No. 3,692,744. Examples of preferred branching agents are trimesic acid, trimellitic acid, trimethylolethane, trimethylolpropane and pentaerythritol.

Polyalkylene terephthalates produced only from terephthalic acid and its reactive derivatives (e.g. its dialkyl esters) and ethylene glycol and/or 1,4-butanediol, and mixtures of these polyalkylene terephthalates, are particularly preferred.

Mixtures of polyalkylene terephthalates contain 1 to 50 wt. %, preferably 1 to 30 wt. %, polyethylene terephthalate and 50 to 99 wt. %, preferably 70 to 99 wt. %, polybutylene terephthalate.

The polyalkylene terephthalates preferably used generally possess an intrinsic viscosity of 0.4 to 1.5 dl/g, preferably 0.5 to 1.2 dl/g, measured in phenol/o-dichlorobenzene (1:1 parts by weight) at 25° C. in an Ubbelohde viscometer.

The polyalkylene terephthalates may be produced by known methods (cf. e.g. Kunststoff-Handbuch, volume VIII, pp. 695 ff., Carl-Hanser-Verlag, Munich 1973).

The composition may also contain other conventional polymer additives, such as flame retardants (e.g. halogen compounds or organic phosphorus compounds, preferably bisphenol-A based oligophosphates), anti-dripping agents (e.g. compounds of the fluorinated polyolefin, silicone and aramide fiber classes of substances), lubricants and mold release agents, e.g. pentaerythritol tetrastearate, nucleating agents, antistatic agents, stabilizers, fillers and reinforcing agents (e.g. glass or carbon fibers, mica, kaolin, talc, CaCO₃ and glass flakes) as well as dyes and pigments (e.g. titanium dioxide and iron oxide).

In particular, the composition may also contain those polymer additives that are known to decompose polycarbonates catalytically under typical processing conditions for such compositions. Particularly relevant are oxidic compounds of (transition) metals, such as titanium dioxide, iron oxide, kaolin and talc, which are generally used as fillers, reinforcing agents or pigments.

Production of the Molding Compositions and Shaped Articles

The thermoplastic molding compositions according to the invention may be produced e.g. by mixing the relevant constituents in a known manner and melt-compounding and melt-extruding them at temperatures of 200° C. to 300° C., preferably at 230 to 280° C., in conventional units such as internal mixers, extruders and twin-screw extruders.

The individual constituents may be mixed in a known manner either consecutively or simultaneously, and either at about 20° C. (room temperature) or at an elevated temperature.

In a preferred embodiment, the compositions according to the invention are produced by mixing components A to C and optionally additional components D at temperatures in the range of 200 to 300° C., preferably at 230 to 280° C., and under a pressure of no more than 500 mbar, preferably no more than 200 mbar, in a commercially available compounding unit, preferably in a twin-screw extruder. The conditions of the process according to the invention are therefore selected such that the acid according to component C decomposes in this process, forming compounds that are volatile and/or give a neutral reaction, and the volatile decomposition products are at least partly removed from the composition by means of the vacuum that is applied.

In another special embodiment of this process, component B is first pre-mixed with the acid of component C and optionally other additives according to component D at temperatures in the range of 180 to 260° C. and the mixture thus produced is mixed in a second compounding step at a temperature in the range of 200 to 300° C., preferably 230 to 280° C., and under a pressure of no more than 500 mbar, preferably no more than 200 mbar, in a commercially available compounding unit with component A and optionally other components D.

In another preferred embodiment of this process, the pre-mix of components B and C, optionally together with other additives according to component D, is passed in the form of a polymer melt into a melt stream of component A, which has a temperature of 220 to 300° C., and the polymer components are then dispersed in one another.

The invention therefore also provides a process for the production of the compositions according to the invention.

The molding compositions according to the invention may be used to produce all kinds of molded articles. These may be produced e.g. by injection molding, extrusion and blow-molding processes. Another form of processing is the production of articles by thermoforming from previously produced sheets or films.

Examples of these articles are films, profiles, all kinds of housing parts, e.g. for domestic appliances, such as juice presses, coffee machines, mixers; for office equipment, such as monitors, flat screens, notebooks, printers, copiers; sheets, pipes, ducts for electrical installations, windows, doors and other profiles for the construction sector (interior fittings and exterior applications) as well as electrical and electronic parts, such as switches, plugs and sockets and components for utility vehicles, particularly for the automotive sector.

In particular, the molding compositions according to the invention may also be used, for example, to produce the following shaped articles or moldings: interior fittings for rail vehicles, ships, aircraft, buses and other motor vehicles, body parts for motor vehicles, housings for electrical appliances containing small transformers, housings for equipment for data processing and data transfer, housings and casings for medical equipment, massage equipment and housings therefor, toy vehicles for children, flat wall panels, housings for safety equipment, thermally insulated transport containers, moldings for sanitary and bathroom fittings, covering grid plates for ventilation openings and housings for garden equipment.

The invention is further illustrated but is not intended to be limited by the following examples in which all parts and percentages are by weight unless otherwise specified.

### EXAMPLES

Component A

Linear polycarbonate based on bisphenol A having weight-average molecular weight, M̅_{w}, of 27500 g/mol (determined by GPC).

Component B-1

An ABS polymer, produced by pre-compounding 50 wt. % of an ABS graft polymer produced by an emulsion polymerization process and 50 wt. % of an SAN copolymer. Component B-1 is distinguished by an A:B:S weight ratio of 17:26:57 and contains substances that act as Bronsted bases resulting from its production, as may be deduced from the pH of the cold-ground component B-1 of 8.4, measured according to ISO 787/9.

Component B-2

A physical mixture of 85 wt. %, based on component B-2, of an ABS polymer produced by pre-compounding 50 parts by weight of an ABS graft polymer produced by an emulsion polymerization process and 50 parts by weight of an SAN copolymer, with 15 wt. %, based on component B-2, of another SAN polymer. Component B-2 is distinguished by an A:B:S weight ratio of 20:24:56. The pH of the powdered ABS graft polymer used in component B-2 is 5.5, from which it may be deduced that the ABS graft polymer is substantially free of basic impurities resulting from its production. The SAN copolymers used in component B-2 contain no constituents that act as bases.

Component C-1

Citric acid monohydrate (Merck KGaA, Darmstadt, Germany)

Component C-2

Oxalic acid (Sigma-Aldrich Chemie GmbH, Steinheim, Germany)

Component C-3

Terephthalic acid, >99% (Fluka, Germany)

Component D-1

Irganox B900 (Ciba Specialty Chemicals Inc., Basel, Switzerland)

Component D-2

Pentaerythritol tetrastearate

Component D-3

TiO₂: Kronos 2233 (Kronos Titan GmbH, Leverkusen, Germany); pH measured according to ISO 787/9 in a mixture of 50 wt. % water and 50 wt. % 2-propanol, is 5.8.

Production and Testing of the Molding Compositions According to the Invention

Production Process 1:

The mixing of all the components A to D takes place in a single compounding step in a twin-screw extruder (ZSK-25, Werner u. Pfleiderer, Stuttgart, Germany) at a melt temperature of about 260° C. and under a pressure of about 100 mbar.

Production Process 2:

The mixing of components B and C takes place in an upstream compounding step in a 3-litre internal mixer at about 220° C. under normal pressure. The precompound thus produced is mixed with component A and any other components D in a downstream compounding step in a twin-screw extruder (ZSK-25, Werner u. Pfleiderer, Stuttgart, Germany) at a melt temperature of about 260° C. and under a pressure of about 100 mbar.

The test pieces are produced on an Arburg 270 E type injection molding machine at 280° C. with a long residence time of 7.5 min.

A number of measurable variables are used as indicators of the processing stability of the molding compositions thus produced.

Method 1: Change in the Melt Flow (MVR) when the Melt is Stored at Processing Temperature

The MVR of the compounded composition is determined according to ISO 1133 at 260° C. with a 5 kg load. In addition, the MVR of a sample of the compounded composition stored at an elevated temperature (280° C. or 300° C.) for the indicated period (7.5 min or 15 min) is also determined at 260° C. with a 5 kg load. The difference between these two MVR values before and after heat exposure serves as a measure of the degradation in the molecular weight of the polycarbonate and thus of the processing stability of the molding composition.

Method 2: Ductile/Brittle-Temperature in the Notched Impact Experiment

The notched impact resistance aₖ is determined according to ISO 180/1 A at various temperatures on test bars measuring 80 mm×10 mm×4 mm, which were injection-molded at the comparatively high temperature of 280° C. and with a comparatively long residence time of 7.5 min. The aₖ ductile/brittle-temperature represents the temperature at which a ductile fracture or a brittle fracture was observed in about half of all the experiments performed in this notched impact experiment. This is a measure of the processing stability of the molding composition.

Method 3: Intrinsic Color Under More Severe Processing Conditions

Again at 280° C. and with a residence time of 7.5 min, color sample sheets were injection-molded and their yellowness index (YI) was measured by spectrophotometry. A light intrinsic color (i.e. a low YI) is an indicator of good processing stability.

The change in MVR, measured according to ISO 1133 at 260° with a 5 kg load before and after storing the granules for 7 days at 95° C. and 100% relative humidity, is a measure of the hydrolysis resistance of the molding compositions.

TABLE 1

| | C1 | 1 | 2 | C2 | 3 | 4 | C3 |
|---|---|---|---|---|---|---|---|
| A (PC) | 58 | 58 | 58 | 58 | 58 | 58 | 58 |
| B-1 (ABS) | 42 | 42 | 42 | 42 | 42 | 42 | 42 |
| C-1 (citric acid) | — | 0.1 | 0.1 | 0.2 | — | — | — |
| C-2 (oxalic acid) | — | — | — | — | 0.1 | — | — |
| C-3 (terephthalic acid) | — | — | — | — | — | 0.1 | 0.2 |
| D-1 (stabilizer) | 0.12 | 0.12 | 0.12 | 0.12 | 0.12 | 0.12 | 0.12 |
| D-2 (mold release | 0.75 | 0.75 | 0.75 | 0.75 | 0.75 | 0.75 | 0.75 |
| agent) | | | | | | | |
| Production process | 1 | 1 | 2 | 1 | 1 | 1 | 1 |
| ΔMVR | 33 | 7 | 2 | 7 | 19 | 11 | 14 |
| (300° C./15 min) | | | | | | | |
| [ml/10 min] | | | | | | | |
| aₖ ductile/brittle- | 0 | −30 | −30 | −25 | −30 | −25 | −25 |
| temperature [° C.] | | | | | | | |
| Yellowness index (YI) | 23 | 25 | 30 | 27 | 21 | 28 | 31 |
| ΔMVR | 11 | 11 | 9 | 13 | 11 | 14 | 13 |
| (7 d/95° C./100% r.h.) | | | | | | | |
| [ml/10 min] | | | | | | | |

It may be seen from the data in Table 1 that, by adding small quantities of acid, the poor processing stability of the polycarbonate compositions caused by the substances acting as bases in the ABS component B may be clearly improved (compare Comparative Example 1 with Examples 1, 3 and 4). Adding larger quantities of acid does not bring about any firther improvement in the processing stability, but leads to a deterioration in the intrinsic color and also, in some cases, the hydrolysis resistance (compare Example 1 with Comparative Example 2 and Example 4 with Comparative Example 3). The use of those acids that undergo thermal decomposition under the production conditions of the compositions to release volatile and/or neutral compounds, such as oxalic acid and citric acid, proves advantageous with regard to the intrinsic color and especially the hydrolysis resistance (compare Examples 1, 3 and 4). Citric acid proves particularly advantageous with regard to improving the processing stability (compare Examples 1, 3 and 4). In addition, it proves advantageous with regard to the processing stability and hydrolysis resistance to pre-mix components B and C in the melt initially (compare Examples 1 and 2). A process of this type proves advantageous particularly for colored materials, in which the disadvantages of this process in terms of the natural shade of the molding composition do not become apparent.

TABLE 2

| | C4 | 5 | 6 | 7 |
|---|---|---|---|---|
| A (PC) | 58 | 58 | 58 | 58 |
| B-2 (ABS) | 42 | 42 | 42 | 42 |
| C-1 (citric acid) | — | 0.02 | 0.05 | 0.1 |
| D-1 (stabilizer) | 0.12 | 0.12 | 0.12 | 0.12 |
| D-2 (mold release agent) | 0.75 | 0.75 | 0.75 | 0.75 |
| D-3 (TiO2) | 5 | 5 | 5 | 5 |
| Production process | 1 | 1 | 1 | 1 |
| MVR [ml/10 min] | 15 | 13 | 13 | 12 |
| MVR (280° C./7.5 min) [ml/10 min] | 22 | 20 | 18 | 16 |
| ΔMVR [ml/10 min] | 7 | 7 | 5 | 4 |
| aₖ ductile/brittle-temperature [° C.] | +10 | −5 | −15 | −15 |
| ΔMVR (7 d/95° C./100% r.h.) | 16 | 17 | 17 | 17 |
| [ml/10 min] | | | | |

It may be seen from the data in Table 2 that the processing stability of those compositions that contain no basic compounds but do contain oxidic metal compounds (titanium dioxide in this case) may also be clearly improved by adding small amounts of acid. The hydrolysis resistance of the molding compositions is not negatively affected by this.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic molding composition comprising
A) 10 to 90 parts by weight of at least one member selected from a first group consisting of aromatic polycarbonate and polyester carbonate,
B) 10 to 90 parts by weight of a member selected from a second group consisting of B.1 rubber-modified graft polymer and a mixture of B.1 with (B.2) rubber-free (co)polymer of at least one monomer selected from a third group consisting of vinyl aromatic, vinyl cyanide, C₁-C₈ alkyl(meth)acrylate, unsaturated carboxylic acid and derivative of unsaturated carboxylic acid,
C) 0.005 to 0.15 parts by weight, based on 100 parts by weight of the sum of components A and B, of at least one member selected from the group consisting of aliphatic organic carboxylic acid and aromatic organic carboxylic acid,
whereby component C) is mixed with the melt of components A) and B) or whereby component C) is in a first step premixed with component B) and in a second step the resulting mixture of A) and B) is mixed with a melt comprising component A).

2. The molding composition according to claim 1, containing 0.01 to 0.15 parts by weight of component C.

3. The molding composition according to claim 1, containing 0.015 to 0.13 parts by weight of component C.

4. The molding composition according to claim 1 wherein component C is at least one member selected from the group consisting of aliphatic dicarboxylic acid, aromatic dicarboxylic acid and hydroxyfunctionalized dicarboxylic acid.

5. The molding composition according to claim 1 wherein component C is at least one member selected from the group consisting of citric acid, oxalic acid and terephthalic acid.

6. The molding composition according to claim 5 wherein component C is citric acid.

7. The molding composition according to claim 1 wherein said A) is present in an amount of 40 to 80 parts by weight.

8. The molding compositions according to claim 1 wherein said A) is present in an amount of 55 to 75 parts by weight.

9. The molding composition according to claim 1 further comprising at least one constiuent that act as a base.

10. The molding composition according to claim 1 wherein said (B.1) is a product of emulsion polymerization process and contains at least one constituent that acts as bases derived from its polymerization or processing said.

11. The molding composition according to claim 1 further comprising at least one member selected from the group consisting of polyalkylene terephthalates, flame retardants, anti-dripping agents, lubricants, mold release agents, nucleating agents, antistatic agents, stabilizers, fillers, reinforcing agents, dyes and pigments.

12. The molding composition according to claim 1 further comprising an oxidic metal compound.

13. The molding compositions according to claim 1 further comprising titanium dioxide.

14. A process for the production of the composition according to claim 1, comprising mixing said A), B) and C) at temperatures in the range of 200 to 300° C. and degassing under a pressure of no more than 500 mbar in a compounding unit.

15. A process for the production of the composition according to claim 1, comprising mixing said B) with said C) at temperatures in the range of 180 to 260° C. to produce a pre-mixture and mixing said pre-mixture with said A) in a compounding unit at a temperature in the range of 200 to 300° C. and degassing under a pressure of no more than 500 mbar.

16. A process for the production of the composition according to claim 1, comprising mixing said B) with said C) at temperatures in the range of 180 to 260° C. to produce a molten pre-mixture ard passing the molten pre-mixture into a melt stream of said A) at temperature of 220 to 300° C., to produce a homogeneous molten mixture.

17. An article comprising the composition of claim 1.
